(19) United States
(12) Patent Application Publication
(10) Pub. No.: US 2006/0031934 A1
(43) Pub. Date: Feb. 9, 2006

(54) Monitoring system

(75) Inventor: Kevin Kriegel, Highland Park, IL (US)

Correspondence Address: BRINKS HOFER GILSON & LIONE, P.O. BOX 10395, CHICAGO, IL, 60610, US

(73) Assignee: STONEWATER CONTROL SYSTEMS, INC.

(21) Appl. No.: 11/195,930

(22) Filed: Aug. 2, 2005

Related U.S. Application Data
(60) Provisional application No. 60/598,984, filed on Aug. 4, 2004.

(51) Int. Cl. G06F 12/14; G06F 11/00; G06F 11/36; G06F 11/22; G06F 11/30; G06F 11/32; G06F 11/34; G06F 12/16; G06F 15/18; G08B 23/00

(52) U.S. Cl. 726/22; 726/23; 726/25

(57) ABSTRACT

A system monitors and controls devices that may sense and report a location's physical characteristics through a distributed network. Based on sensed characteristics, the system may determine and/or change a security level at a location. The system may include a sensor, an access device, and a data center. The sensor detects or measures a condition at a location. The access device communicates with the sensor and the data center. The data center communicates with devices in the system, manages data received from the access device, and may transmit data to the access device.

### PRIORITY CLAIM

This application claims the benefit of priority from U.S. Provisional Application No. 60/598,984, filed Aug. 4, 2004, which is incorporated herein by reference.

### BACKGROUND OF THE INVENTION

1. Technical Field

This invention relates to a monitoring and control system, and more particularly to a system that monitors and controls devices across a distributed network.

2. Related Art

A monitoring device may be controlled across a network. In some systems, an individual near the monitoring device detects and communicates a problem before a control center responds.

In other systems, a monitoring device may transmit a state condition to a facility. In these systems, the monitoring devices transmit limited information. The transmitted information may not include information describing the cause or severity of the condition. In such cases, a response team may not be prepared to respond to the condition.

Therefore there is a need for a monitoring and control system that analyzes characteristics at a location.

### SUMMARY

A system monitors and controls devices that may sense and report a location's physical characteristics through a distributed network. Based on sensed characteristics, the system may determine and/or change a security level at a location. The system may include a sensor, an access device, and a data center. The sensor detects or measures a condition at a location. The access device communicates with the sensor and the data center. The data center communicates with devices in the system, manages data received from the access device, and may transmit data to the access device.

The system may include a sensor, a network access device, a controller, a display, and a data center. The sensor detects a changing characteristic at a location. The network access device determines a security level from an input signal, which may be derived from the sensed data. The controller communicates with the network access device and the display to provide a visual or audible notification of the security level.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a partial block diagram of a monitoring and control system.

FIG. 2 is a partial block diagram of a network access device.

FIG. 3 is a partial block diagram of a data center.

FIG. 4 is a partial block diagram of an alternate monitoring and control system.

FIG. 5 is a visual display of FIG. 4.

FIG. 6 is an alternate visual display of FIG. 4.

FIG. 7 is a flow diagram of a monitoring and control system.

### DETAILED DESCRIPTION OF THE PREFERRED EMBODIMENTS

A system monitors devices that may sense and report the characteristics through a distributed network. The system may identify physical characteristics at a location, analyze the sensed data, and transmit a stored or real-time undifferentiated byte-by-byte flow of data to a data center. By tracking physical characteristics at remote locations, the system may identify the presence of a security threat. The system may notify specific individuals of security conditions, permit some or all of these individuals to review the sensed data, reconstruct the manner in which a security threat was detected; or initiate an auto-correction sequence.

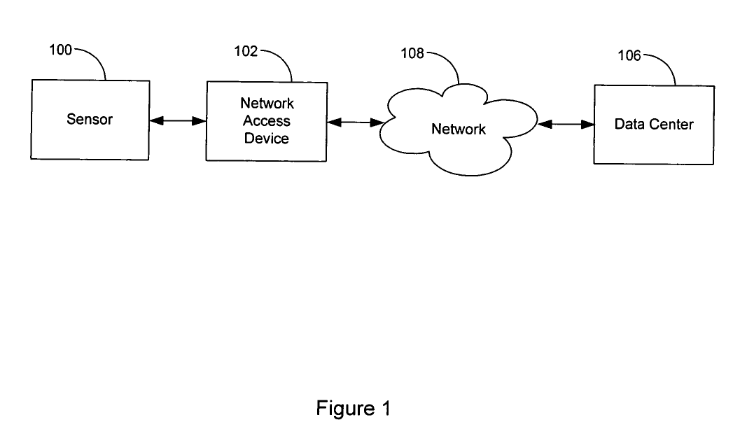

FIG. 1 is a partial block diagram of a monitoring and control system. The system may include hardware or software that is capable of running on one or more processors in conjunction with one or more operating systems. The system may include sensor 100, network access device 102, data center 106, and a distributed network 108, such as a private or publicly available distributed network.

A private distributed network may be a network in which the network links are separate from publicly accessible communication links. Virtual private networks may be networks that utilize secure communications over publicly accessible communication links. Virtual private networks may be publicly accessible networks. Publicly or privately accessible networks may be configured to use open or secure communications.

In FIG. 1, sensor 100 and a network access device 102 may reside at a common location remote from the data center 106. Sensor 100 may be a single or multifunctional controllable sensor capable of identifying and modeling in real time (e.g., an operation, such as a transmission; a transmission and acknowledgement; or a processing of data, which occurs at or near the same rate of time perceived by a human) or in delayed time (e.g., batch) the properties or derivatives at a location. The sensor 100 may include any type of monitoring device that can monitor, sense, and/or identify properties or derivatives representing physical conditions. These conditions may occur in liquids, solids, or gases. The sensor 100 may be sensitive to motion, may convert sound waves into electrical signals, may measure a sound level, may measure the emission and the amount of dispersion of a liquid or a gas, may measure light spectra; other sensors may measure atmospheric conditions, may record moving or static images, or may measure a compilation of characteristics described above. Where a sensor includes or is linked to a device that may record moving or static images, the image capturing portion of the device may be pointed in a particular direction based on sensory data, such as echo detection, motion detection, or an audible signal, and may record on transmit image in real or batched time.

The sensed, identified, and/or modeled characteristics may be analyzed to detect a changing security level. Analysis may occur through an analog or digital comparison of the modeled physical characteristics with a programmable library of known security level thresholds retained in an integrated or remote memory of sensor 100. Alternatively, analysis may include a statistical analysis of the sensed data. Statistical analyses may include combining multiple data samples in a mathematical expression to generate a new type of data or to create a probability estimate of a security threat. A timestamp may be associated with some or all of the analyzed data points and the combined information may be stored in a volatile or non-volatile memory.

A security level threshold may be a configurable parameter that if matched or exceeded indicates a changed condition. The security level threshold may be configured by a supervising agency or supervising personnel. A security level threshold may be the identification of a gunshot sound, movement in a restricted area, an increased concentration of a dangerous substance, and/or a harmful concentration of a chemical substance.

A security threat may exist when a security level changes. When a change in a security level is detected, sensor 100 may transmit a data stream containing the sensed or identified data, the modeled and analyzed data, as well as a security notification signal to data center 106 through network access device 102 and a private or publicly accessible distributed network 108. Some or all of the data stream contents may be transmitted in a format that requires less space than usual. When data is transmitted in this format, compression techniques may be used such that the restored data is an accurate depiction of the original data. A security notification signal may indicate that the security level has changed.

In addition to identifying and modeling the physical characteristics at a predetermined location, sensor 100 may automatically transmit (“push”) at a periodic user configurable interval a status signal. The status signal may be transmitted to network access device 102 where it may be stored in a volatile or non-volatile memory and/or transmitted in real or delayed time to data center 106 through a private or publicly accessible distributed network 108. If either network access device 102 or data center 106 fails to receive an expected status signal, an alert condition may be generated at data center 106 indicating a possible problem with sensor 100 or network access device 102. Sensor 100 may be enclosed in a protective housing shielded from moisture, high temperature, and changes in violent pressure (e.g., mechanical, chemical, or nuclear explosions) and configured with an internal environmental sensing mechanism. If a condition such as temperature, pressure, or humidity, is not within a threshold range, sensor 100 may send data and information to the data center 106 and/or cause an alarm to be generated at data center 106.

Network access device 102 may be programmable and may bridge one or more sensors 100 and data center 106 through a private or publicly accessible distributed network 108. If the system is accessed by an unauthorized individual, network access device 102 may take active measures to identify and/or prevent the intrusion. On the local side, network access device 102 may request data from multiple devices through multiple protocols individually or simultaneously. These protocols may include Extensible Markup Language (“XML”) over Hyper Text Transfer Protocol (“HTTP”), Simple Network Management Protocol (“SNMP”) over Transmission Control Protocol/Internet Protocol (“TCP/IP”), Simple Object Access Protocol over TCP/IP, Master-Slave/Client-Server communication between intelligent devices (“Modbus”) over RS-232 and RS-485, data communication protocols for Building Automation and Control (“BACnet”), LonTalk, as well as proprietary protocols developed in house and by others. Alternatively, the network access device 102 may communicate with the interfaced devices through wireless protocols through wireless transceivers. The wireless protocols may include 802.11b, 802.11j, 802.11g, ZigBee, Ultra Wide Band, Mobile FI, or other developing wireless protocols. Network access device 102 may communicate with distributed network 108 through various communication technologies, such as Ethernet, Digital Subscriber Lines (“DSL”), Plain Old Telephone Service (“POTS”), Cellular Digital Packet Data (“CDPD”), Code Division Multiple Access (“CDMA”), Global System for Mobile communication (“GSM”), 802.11, and Satellite links.

The data center 106 may comprise one or more computers or controllers coupled to distributed network 108. Data center 106 may communicate bi-directionally with network access device 102, process and analyze all or some of the data received from the network access device 102, and store some or all of the communications received from the network access device 102. Some or all of the data may be stored in a format that requires less space than usual. Additionally, the data center may monitor the functionality of sensor 100; modify and store system parameter changes locally or remotely; and communicate with users of the system.

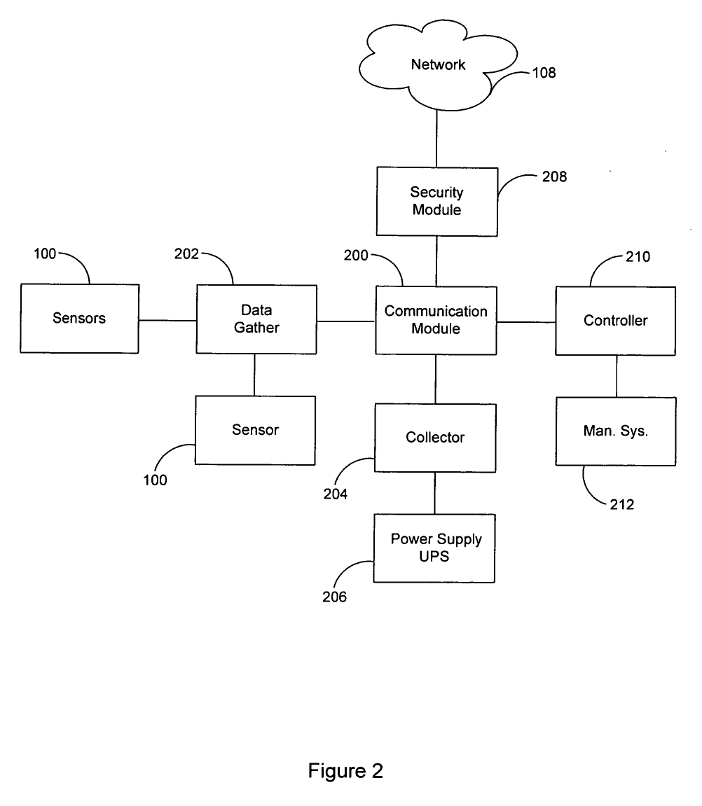

FIG. 2 is a partial block diagram of network access device 102. Network access device 102 may be located at a remote location such as within a structure, or mobile, such as within a vehicle. Network access device 102 may include communication module 200, a data gathering device 202, a collector 204, a universal power supply (“UPS”) 206, a security module 208, a controller 210, and/or a management system 212. Some or all of the elements comprising network access device 102 may be contained within a unitary device. Network access device 102 may be enclosed in a protective housing shielded from moisture, high temperature, and changes in violent pressure (e.g., mechanical, chemical, or nuclear explosions) and configured with an internal environmental sensing mechanism. If a condition such as temperature, pressure, or humidity, is not within a threshold range, network access device 102 may send data and information to the data center 106 and/or cause an alarm to be generated at data center 106.

Communication module 200 may comprise a computer which varies in size and performance depending on the tasks. Communication module 200 may comprise multiple ports for interfacing one or more sensors 100. Each sensor 100 may have a unique numerical, alpha-numerical, or other indicia of identification that may allow direct communication with communication module 200 or data center 106. If a sensor 100 is mobile the unique identification indicia may include a global positioning satellite reference or alternatively may correspond to a network or internet protocol addressed used to access the system. Sensor 100 may directly interface communication module 200. Additionally, communication module 200 may be configured to directly interface a device that forwards data including a destination address across a network, a device that enables the transmission of data across landlines or cable lines, a controller, a data gathering device 202, or other network appliances. Communication module 200 may communicate sequentially or simultaneously with interfaced devices through multiple protocols through a device application program interface (“API”). These protocols may include XML, HTTP, SNMP over TCP/IP, Simple Object Access Protocol over TCP/IP, Modbus over RS-232 and RS-485, BACnet, LonTalk, as well as other public or proprietary protocols developed in house and by others. Alternatively, communication module 200 may communicate with interfaced devices through wireless protocols through wireless transceivers. The wireless protocols may include 802.11b, 802.11j, 802.11g, ZigBee, Ultra Wide Band, Mobile FI, CDMA, GSM, Satellite links, or other developing wireless protocols.

Communication module 200 may receive data from sensor 100, data gathering device 202, or collector 204. The received data may include (1) the sensed or identified data; (2) a status signal, (3) data modeling the physical characteristics sensed at a remote location, and/or (4) a security level notification signal.

The sensed and/or modeled and analyzed data detected at the remote location and resident within sensor 100, data gathering device 202, or collector 204 may be periodically accessed at a user configurable interval (“polled”) to determine the status of each device so that active programs can process the events generated by each device. If upon receiving the sensed and/or modeled and/or analyzed data it is determined that a security level should change, a security level notification signal may be generated and/or the users of the system may be alerted about to this change.

The data received by communication module 200 from sensor 100, data gathering device 202, or collector 204 may be stored locally within communication module 200 in a round robin database or remotely. Data may be stored in a compressed and/or uncompressed format. If communications between communication module 200 and data center 106 is lost, the data stored in the communication module 200 database may remain within the communication module 200. Once the communication path is restored, data center 106 may request some or all of the missing data from the communication module 106. Alternatively, the communication module 200 may synchronously or asynchronously check continuity. When a communication path is restored, the communication module 200 may transmit some or all of its data. The level of communication may be controlled by a log maintained in the communication module 200 or the data center 106.

As an alternative to sensor 100 analyzing and/or modeling the properties representing physical conditions at a location, analysis and/or modeling may occur within communication module 200. Communication module 200 may poll sensor 100, data gathering device 202, or collector 204 for sensed data representing the physical characteristics at a location. This data may have a timestamp associated with some or all of the data points and this combined data may be stored in a volatile or non-volatile memory in communication module 200. Similar to sensor 100, communication module 200 may also store a programmable library of security level thresholds in a volatile or a non-volatile memory. Communication module may analyze and/or model the data through an analog or digital comparison with the stored security threshold levels. If the comparison determines that a security level should change, a security level notification signal may be generated and/or the users of the system may be alerted about to this change. Alternatively, modeling and analysis of the data may include a statistical analysis. Statistical analyses may include combining multiple data samples in a mathematical expression to generate a new type of data or to create a probability estimate of a security threat.

Communication module 200 may include failsafe capabilities in the event that a primary communication path or data center 106 is unavailable. These failsafe capabilities may include contacting data center 106 through one or more protocols or scanning one or more wireless frequencies by incrementally transmitting a signal to a wireless transceiver. If a response is not received, the communication module 200 may test the other frequency bands integrity and signal strength. The communication module 200 may be configured to systematically analyze each communication path before proceeding to the next communication path. For exemplary purposes, if the primary communication path between communication module 200 and data center 106 is Ethernet, and communication module 200 is unable to communicate with a primary data center 106, communication module 200 may switch its communication path to a secondary data center 106. Once all data centers on a primary communication path (e.g., Ethernet) have been exhausted, an alternate communication path, such as wireless transmission, may be attempted. Alternate modes of communication may be attempted until a connection is made, a strongest channel is identified, and/or highest data intensity is found. However, if no communication with data center 106 has occurred after a programmable period of time, the communication module 200 may reboot and restart all or some of its processes.

To ensure proper operation, local or remote troubleshooting or upgrade procedures may be performed on communication module 200. These procedures may include restarting some or all of communication module's 200 processes, performing diagnostics, or installing upgrades or security patches. Installing upgrades or security patches may include establishing a connection with communication module 200, requesting the current software version loaded on communication module 200, comparing this version to a version stored on an external computer, transmitting the updated version to communication module 200, and integrating into a memory of communication module 200 some or all of the programs transmitted. Alternatively, an upgrade or patch may be installed by transmitting and integrating programs into a memory of communication module 200 without checking the current version stored on the device. Additionally, troubleshooting or upgrade procedures may be performed on the devices interfaced to communication module 200 by using communication module 200 as a gateway or entrance point to the individual devices.

The data gathering device 202 may interface directly or wirelessly to communication module 200 and/or sensor 100 to retrieve stored or instantaneous data residing in sensor 100. The data requested from sensor 100 may be an analog or digital signal. Conditioning may occur either on or off of the data gathering device 202. When data gathering device 202 and sensor 100 are interfaced directly, multiple protocols may be used for communications between the two devices. These protocols may include RS-232, RS-485, or others through TCP/IP over Ethernet. Alternatively, when data gathering device 202 and sensor 100 are wirelessly interfaced, open source or proprietary protocols may be used for communications between the two devices.

Data gathering device 202 may be polled by communication module 200 to receive the data gathered from sensor 100. If during this polling, communication module 200 determines that data is missing, that data gathering device 202 cannot be polled, or that data gathering device 202 is offline, network access device 102 may notify the data center 106.

The collector 204 of network access device 102 may collect sensor and other data off the network. This data may be polled by communication module 200, stored locally within communication module 200, and/or pushed across a private or publicly accessible distributed network 108 to the data center 106.

Network access device 102 may include UPS 206 that allows for a backup power supply. UPS 206 may interface directly to communication module 200 for constant monitoring of information regarding UPS' 206 output status or percentage of battery life. Information regarding the status of UPS 206 may be polled for by communication module 200, stored locally within communication module 200, and pushed across the network 108 to data center 106.

Security module 208 may house a firewall, logic to detect a system intruder, or encryption logic. The firewall may be designed to prevent an unauthorized user from accessing the system. Hardware, software, or a combination of both may be used to implement the firewall. The firewall may (1) examine each packet of data entering or leaving network access device 102 and accept or reject the data based on user-defined rules, (2) apply security mechanisms to specific applications, such as File Transfer Protocol or Telnet services, (3) apply security mechanisms when a connection such as TCP is established, such that once the connection is made packets of data may freely flow between computers without further checking, or (4) intercept all messages entering or leaving the network. Additionally, the firewall may utilize one or more of these techniques separately or together.

Intrusion detection logic may be used to collect information regarding a system intrusion. Security module 208 may transmit information into the distributed network 108 such that the system appears to be an open or unsecured node. When an unauthorized use is detected an audit trail may have all activities affecting the information accessed or information received, information that makes it possible to document who had access to the data, made changes to the data, and when changes to the data were made

Encryption logic may be used to secure communications between network access device 102 and data center 106. Security module 208 may include key encryption logic, such as where a first key is used to encrypt data, and a second secret key is used to decrypt the data. A Secure Socket Layer (“SSL”) may also be used to establish a secure connection between the communication module 200 and a remote device such that any amount of data may be securely transferred. Alternatively, security module 208 may use a Secure Hyper Text Transfer Protocol (“S-HTTP”), where each individual message is securely transmitted.

Controller 210 may transmit signals as directed by communication module 200. These signals may be initiated remotely through data center 106, or locally based on sensor data or by another local command authority. The signals transmitted by controller 210 may be control signals which may include switching commands (e.g., relay contact closures). Alternatively, the control signals may include detailed instructions relating to a security notification signal. Additionally, control signals may include a return acknowledgement request requesting confirmation that a control action occurred. Return acknowledgements may be timestamped and stored in volatile or non-volatile memory in communication module 200 or tracked in an audit trail.

Management system 212 may comprise an energy management system or a building management system that may interface controller 210. The management system may monitor and control building operation systems such as an energy grid, a generator, lighting systems, ventilation systems, heating systems, elevator systems, or fire extinguishing systems. Management system 212 may communicate with controller 210 through control signals or through programmed commands either of which may initiate the processing of a sub-routine to control one or more of the building operation systems interfaced with management system 212.

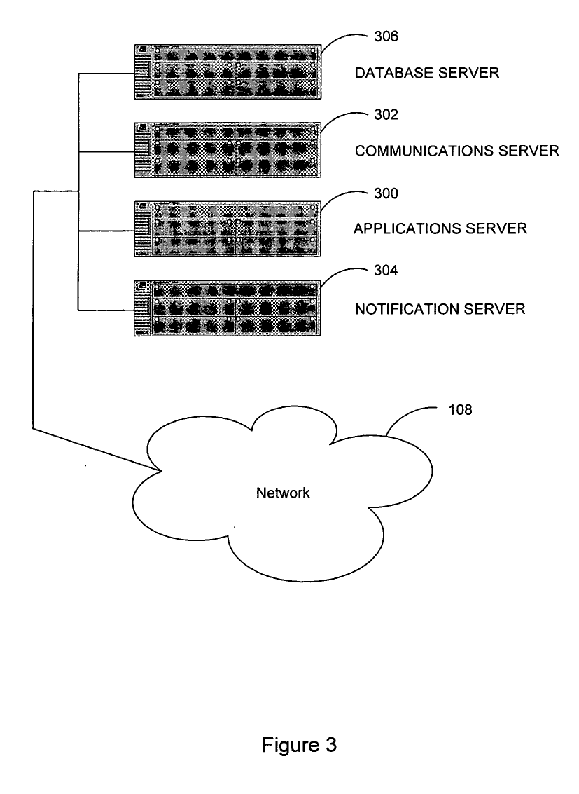

FIG. 3 is a partial block diagram of data center 106. Data center 106 may include one or more servers. Application server 300 may comprise some or all of the human-machine-interface (“HMI”) tools for the remote configuration of network access device 102 and its associated components; data analysis tools; monitoring and scheduling parameters; graphical user interfaces (“GUIs”), other servers, or some or all of the remote devices; notification GUIs allowing for the selection of various modes of communication with end users through email, voice over IP, text message, and the like; and other programs available to a end user through a Web server.

Communication server 302 may handle some or all of the incoming communications from network access device 102. Communication server 302 may additionally transmit other configuration instructions for network access device 102 that it has received from application server 300.

Notification server 304 may receive its instructions from application server 300. Notification server 304 may be programmed with user configurable parameters, such as which persons should be notified for each security notification signal received, during which time periods certain persons should be notified, or how many similar security notifications must be received before certain events occur. Notifications may occur by wired or wireless communications sent through a wireless device, a paging device, a portable email device, or the like. A notification may indicate the type of security notification signal detected; the severity of the notification signal detected; the date, time, and location at which the signal was detected; and/or a password or secure login necessary to access the system.

Database server 306 may collect some or all of the incoming stored or contemporaneous data from network access device 102. This incoming data may include device status signals, security notifications, and/or the sensed, analyzed, and/or modeled data, or any combination of data. Additionally, database server 306 may collect stored or contemporaneous data representing communication activity between a user and application server 300, including configuration changes, alarm conditions, notification attempts, and other vital network status information. Data stored in database server 306 may be stored in an uncompressed or compressed format, where the recovery of the compressed data may be an accurate depiction of the original uncompressed data.

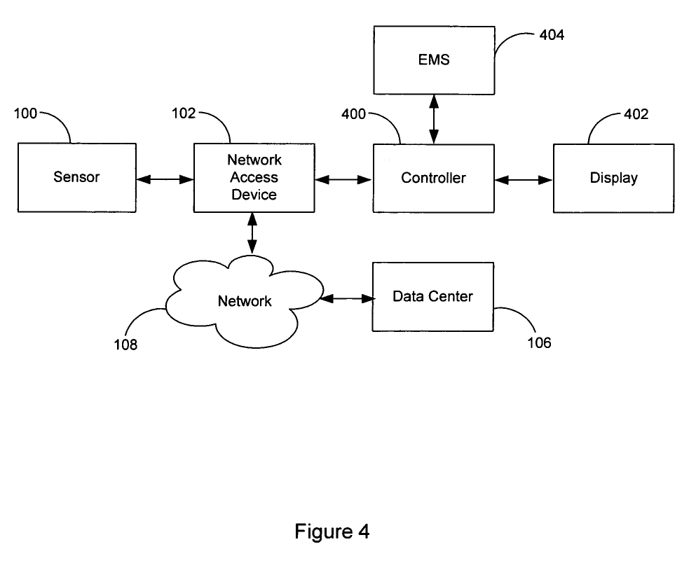

FIG. 4 is a partial block diagram of an alternate monitoring and control system. In FIG. 4, display 400 may interface the network access device 102, or directly interface the controller 210. Display 400 may receive signals transmitted by controller 210 through landlines or wirelessly. The received information may be displayed in real-time as a result of the modeled or analyzed data. Alternatively, the information displayed may be the result of a signal transmitted by data center 106 through distributed network 108. Display 400 may provide a visual notification, an audible notification, a combination of notifications, or no notification. In addition to transmitting display information to display 400, controller 210 may run diagnostic tests on display 400. If controller 210 determines that a diagnostic test has failed or that display 400 is not responding, controller 210 may cause an alarm to be generated at data center 106 indicating a fault with display 400.

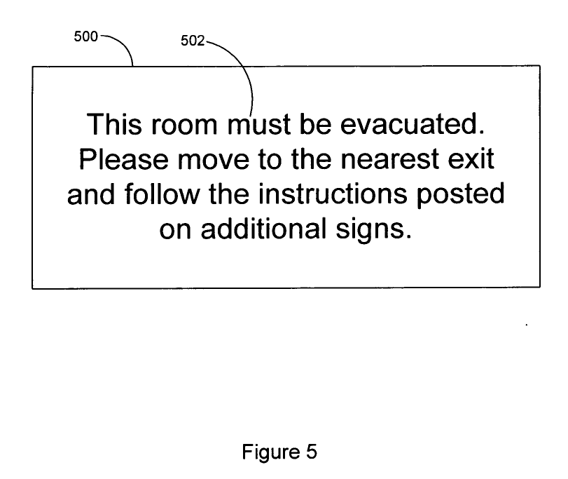

FIG. 5 illustrates an exemplary visual display 500. Display 500 comprises a visual output device that transmits text or graphics. It may comprise light emitting diodes (“LED”), a liquid crystal display (“LCD”), a plasma display panel (“PDP”), a flat panel display, a flat panel display including an organic light emitting diode, a visual graphics array (“VGA”) monitor, a super VGA (“SVGA”) monitor, an extended graphics array (“XGA”), a scrolling display panel, or other devices that may display messages. Message 502 may comprise one of a plurality of predetermined messages stored in a volatile or non-volatile memory within controller 210; the desired message displayed in response to a signal transmitted from network access device 102. Alternatively, message 502 may be a variable message configured at data center 106 and transmitted to display 500 through distributed network 108 and network access device 102. Additionally, display 500 may be configured such that the text of message 502 or the background of display 500 changes colors to correspond with a severity of a security notification signal, such as the color red signifying danger, the color yellow signifying caution, or the color green signifying no security level notification signal. The system may use additional colors to signify variations in a condition. If a color scheme is used to indicate a severity of a security level, message 502 may include the color spelled out in text to assist persons unable to distinguish between colors.

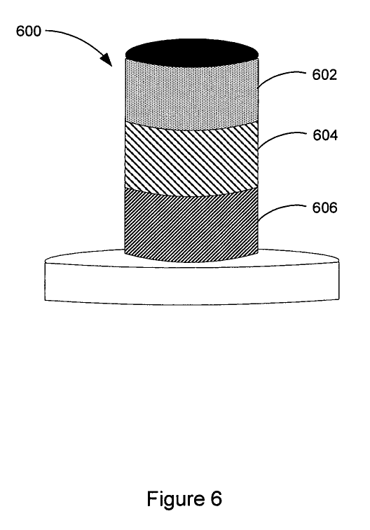

FIG. 6 illustrates an alternate exemplary visual display 600. Display 600 may comprise multiple lighted portions stacked on top of one another. Each portion may be individually illuminated in a different color to correspond to a particular security level. For exemplary purposes, portions 602, 604, and 606 may be illuminated with red, yellow, and green colors, respectively. Based on a detected security level, the system may illuminate a portion of display 600 corresponding to security notifications. Persons within the vicinity of display 600 may take appropriate action in response to viewing an illuminated portion of display 600. A color scheme similar to that of display 500, in FIG. 5, may be used to indicate the security level. To assist persons unable to distinguish between colors, portions 602, 604, and 606 may flash at different rates to designate the different severity levels. While display 600 illustrates three portions, 602, 604, and 606, more or less portions may be used in connection with display 600.

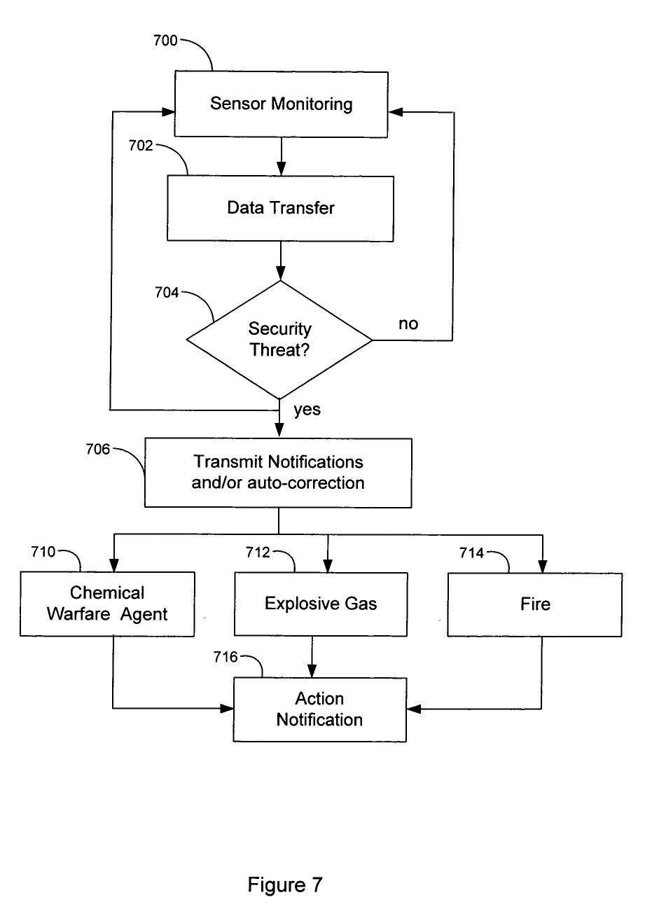

FIG. 7 is an exemplary flow diagram of a system that monitors and controls devices across a distributed network. At act 700, a sensor receives an input sample in real-time or through a batch file representing the characteristics at a location. To assure a good quality measurement, the properties of the input sample may be converted to an electrical signal by an analog-to-digital converter. At act 702, the data representing the input sample may be transmitted to a network access device in response to a data request signal in real-time or batch file. Data request signals may be transmitted to one or more sensors at regular intervals which may be user configurable.

At act 704 a change in a security level may be detected when some or all of a portion of the data representing the input sample matches or exceeds one or more predetermined thresholds. Alternatively, a change in a security level may be predicted through statistical analyses of one or more of the input samples. If a change in a security level is not detected the system may continue to monitor additional input samples; checking these samples for a change in a security level. Alternatively, if a change in a security level is detected, additional input samples may be monitored and, at act 706, a security notification may be transmitted to a display. The security notification may include an audio, visual, or audio/visual notification.

Additionally, at act 706, a data stream may be transmitted across a private or publicly accessible distributed network to a data center, or an optional auto-correction sequence may be initiated. A data stream may include the sensed or identified data, the analyzed and/or modeled data, which may indicated the type of security threat sensed as well as the data responsible for changing the security level, and/or a security notification signal.

An auto-correction sequence may use a linked management system that may take appropriate measures to reduce or eliminate a security threat. These measures may include operation of a specific system depending on the type of security threat sensed. For exemplary purposes, different optional auto-correction sequences may include initiating a sequence when a chemical warfare agent has been sensed, act 710, when an explosive gas has been sensed, act 712, or when a fire has been sensed, act 714. If an optional auto-correction sequence is initiated, at act 710, 712, or 714, a notification signal indicating the commencement of the desired action may be transmitted, at act 716, from the auto-correction system to the data center through the network access device and the distributed network.

The method shown in FIG. 7 may be encoded in a signal bearing medium, a computer readable medium such as a memory, programmed within a device such as one or more integrated circuits, or processed by a controller or a computer. If the methods are performed by software, the software may reside in a memory resident to or interfaced to the network access device 102, the data center 106, or any type of communication interface. The memory may include an ordered listing of executable instructions for implementing logical functions. A logical function may be implemented through digital circuitry, through source code, through analog circuitry, or through an analog source such as through an electrical, audio, or video signal stored or processed by logic. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A system that monitors and controls devices across an accessible network, comprising:
a sensor that detects a characteristic at a location;
a memory configured to store data related to the characteristic;
a programmable logic coupled to the sensor, where the programmable logic is configured to compare the stored data to a second set data stored in the memory; and
a data center configured to receive data related to the comparison through the accessible network.

2. The system of claim 1, where the memory stores data accessed through an autopolling process.

3. The system of claim 1, where the programmable logic detects a change in a security level through an event-driven process.

4. The system of claim 3, where the detection of the security level comprises comparing data in real-time.

5. The system of claim 4, where the programmable logic transmits a security notification across the accessible network upon detecting a change in the security level.

6. The system of claim 5, where the programmable logic is further configured to receive a status signal from the sensor at a regular interval.

7. The system of claim 6, where the programmable logic is programmed to transmit a signal to the data center if it fails to receive the sensor status signal.

8. The system of claim 7, where the programmable logic is coupled to a second network to receive a signal related to a second physical characteristic.

9. The system of claim 1, where the programmable logic is further configured to substantiate a communication path with an interfaced device.

10. The system of claim 1, where the programmable logic is further configured to integrate operation instructions that differ from a set of stored operation instructions.

11. They system of claim 1, where the accessible network is a publicly accessible distributed network.

12. A system that monitors and controls devices over a publicly accessible distributed network, comprising:
a programmable network access device configured to receive data related to a security level;
a programmable logic that statistically analyzes the data related to the security level;
a display coupled to the programmable network access device; and
a data center coupled to the programmable network access device through the publicly accessible distributed network.

13. The system of claim 12, where the display provides a visual or an audible notification.

14. The system of claim 13, further comprising a controller coupled to the programmable network access device and the display, where the controller comprises a transceiver programmed to transmit and receive control and data signals.

15. The system of claim 14, further comprising a sensor coupled to the programmable network access device, where the sensor is configured to detect a changing physical characteristic at a location.

16. A method of monitoring a predetermined location across a publicly accessible distributed network, comprising:
autopolling sensors to collect data representing a characteristic at a location;
storing the data related to the characteristic in a memory;
comparing the stored data to a second set of data;
detecting a changing security level when the compared data matches or exceeds one or more values of the second set of data; and
transmitting the stored data and a notification signal to a data center through a publicly accessible distributed network.

17. The method of claim 16, where the act of detecting a changed security level is performed in real-time.

18. The method of claim 17, further comprising transmitting a signal from the data center to a predetermined number of persons informing the person of the changed security level.

19. The method of claim 18, further comprising transmitting a security notification to a display.

20. A system that monitors and controls devices over a publicly accessible distributed network, comprising:
means for sensing a physical characteristic at a location;
means for detecting a changing security level based on the sensed physical characteristic; and
means for transmitting the changing security level to a data center.

21. The system of claim 20, further comprising means for displaying a security notification.

22. A signal-bearing medium having software that monitors and controls a device across a publicly accessible distributed network, comprising:
a sensor that converts data representing the physical characteristics of a location into electrical signals;
a signal analysis logic that analyzes the electrical signals;
a transceiver coupled to the signal analysis logic that communicates across the publicly accessible distributed network with a data center; and
a programmable logic that detects a changing security level based on the analyzed data and communications from the data center.
